(19) United States
(12) Patent Application Publication
(10) Pub. No.: US 2021/0287145 A1
(43) Pub. Date: Sep. 16, 2021

(54) HEARTSTRINGS MOBILE MUSIC APP

(71) Applicant: Brian Paul Caffrey, Liberty Lake, WA (US)

(72) Inventor: Brian Paul Caffrey, Liberty Lake, WA (US)

(21) Appl. No.: 17/198,148

(22) Filed: Mar. 10, 2021

Related U.S. Application Data
(60) Provisional application No. 62/987,848, filed on Mar. 10, 2020.

(51) Int. Cl. G06Q 10/02; G06Q 20/32; G06Q 10/10; G06Q 20/08; G06F 16/9535; H04N 21/2187; H04N 21/858; H04L 29/08

(52) U.S. Cl. CPC G06Q 10/02; G06Q 20/322; G06Q 10/1095; G06Q 20/0855; G06Q 20/326; H04N 21/2187; H04N 21/858; H04L 67/20; H04L 67/18; G06F 16/9535

(57) ABSTRACT

A system and method for providing live music search, booking, and payment application for a mobile device is disclosed. The mobile device communicatively connected to a web server and one or more client devices. The mobile device includes a memory having instructions stored thereon and a processor configured to execute the instructions on the memory to cause the mobile device to send a search query specifying a current location to seeking an available and currently performing musician, receive a set of search results, the set of search results comprising a name, a location, and a musician profile, receive the music profile of a first musician, receive available schedule information having one or more date and time available appointments associated with the musician, submit a schedule request to the web server scheduling a first appointment with the first musician during a first available appointments, and submit a payment for the first appointment.

### TECHNICAL FIELD

This application relates in general to a system and method for providing live music services application, and more specifically, to a system and method for providing live music search, booking, and payment application.

### BACKGROUND

Music professionals may have a difficult time reaching their audience. Live music musicians, or performers, and music buskers typically rely upon web pages, word of mouth, and pedestrian traffic in any given public venue. Musicians who offer to provide live performances to customers also need an ability to easily provide availability of the musicians on a particular date, as well as receive booking requests and associated payments from audience members. Music buskers typically receive contributions and tips when performing in public if audience members are carrying cash. All of these situations are not well supported by existing on-line services to assist in these needs.

Therefore, a need exists for a web-based application that permits audience members to obtain information, including scheduling data, request booking of the music professional for an event or appointment, and provide payments to music professionals, all in one place. Having all of these operations in a single tool allows musicians to maintain a single on-line presence to reach audience members while at the same time providing an on-line tool that provides the information and services for audience members to connect with the music professionals in desired ways. The present invention attempts to address the existing limitations in a system and method for providing live music search, booking, and payment application according to the principles and example embodiments disclosed herein.

### SUMMARY

In accordance with the present invention, the above and other problems are solved by providing a system and method for providing live music search, booking, and payment application according to the principles and example embodiments disclosed herein.

In one embodiment, the present invention is a system for providing live music search, booking, and payment application. The mobile device communicatively connected to a web server and one or more client devices. The mobile device includes a memory having instructions stored thereon and a processor configured to execute the instructions on the memory to cause the mobile device to send a search query specifying a current location to seeking an available and currently performing musician, receive a set of search results receive available schedule information having one or more date and time available appointments associated with the musician, submit a schedule request to the web server scheduling a first appointment with the first musician during a first available appointments, and submit a payment for the first appointment. The set of search results comprising a name, a location, and a musician profile, receives the music profile of a first musician.

In another aspect of the present disclosure, the available musicians comprises music therapists, live performers, and music buskers.

In another aspect of the present disclosure, the payment comprises one or of the following: a deposit, a partial payment, a full payment, and a donation.

In another aspect of the present disclosure, the available and currently performing musician comprises an individual musician, duo, trio, and full band ensemble.

In another aspect of the present disclosure, the musician profile comprises contact information, address information, and pricing information comprising a name, an address, a phone number, an email address, a mobile number, and a profile picture associated with the available musician.

In another aspect of the present disclosure, the payment is submitted to the web server using a third party payment service.

In another aspect of the present disclosure, the available musician configures the musician profile to display one or more of the following: comprising a name, an address, a phone number, an email address, a mobile number, and a profile picture.

In another aspect of the present disclosure, the current location of the music therapist corresponds to an office zip code and the current location of the music busker corresponds to a specific location to aid users in finding a musician in a public space.

In another aspect of the present disclosure, wherein the profile of the music busker comprises a show video window for viewing a live performance and a pay money button for submitting a donation.

In another aspect of the present disclosure, the profile of the music busker further comprises a hyperlink to a busker channel associated with the music busker providing access or one or more pre-recorded video performances for viewing.

In another embodiment, the present invention is a method for providing live music search, booking, and payment application on a mooble device. The mobile device communicatively connected to a web server and one or more client devices. The method sends a search query specifying a current location to seeking an available and currently performing musician, receives a set of search results, receives available schedule information having one or more date and time available appointments associated with the musician, submits a schedule request to the web server scheduling a first appointment with the first musician during a first available appointments, and submits a payment for the first appointment. The set of search results comprising a name, a location, and a musician profile, receives the music profile of a first musician.

The great utility of the invention is that a system and method for providing live music search, booking, and payment application provides interested audiences this information in one mobile application.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system for providing live music search, booking, and payment application according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-c illustrate example embodiments of user screen shots of a search function within a system and method for providing live music search, booking, and payment application according to the present invention.

FIG. 4 illustrates another embodiment of a user screen shot of musician contact information provided by a system and method for providing live music search, booking, and payment application according to the present invention.

FIGS. 5a-b illustrate example embodiments of user screen shots of musician booking appointment functionality provided by a system and method for providing live music search, booking, and payment application according to the present invention.

FIG. 6 illustrates another embodiment of a user screen shot of musician tip payment functionality provided by a system and method for providing live music search, booking, and payment application according to the present invention.

FIG. 7 illustrates a computing system of software components providing live music search, booking, and payment application according to the present invention.

FIG. 8 illustrates a flowchart corresponding to a method performed by software components of a system for components providing live music search, booking, and payment application on a mobile device according to the present invention.

### DETAILED DESCRIPTION

This application relates in general to a system and method for providing live music search, booking, and payment application according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “musician” and “user” refer to an entity, e.g. a human, that offers professional music services and audience members who seek these music services. In a particular case, “user” corresponds to either a music professional or an audience member who uses a mobile application.

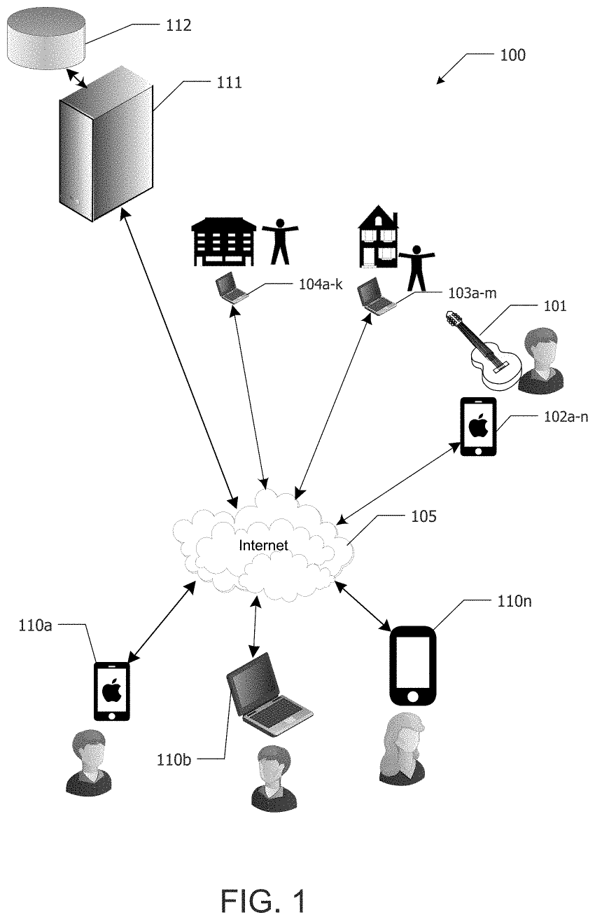

In general, the present disclosure relates a system and method for providing live music search, booking, and payment application. To better understand the present invention, FIG. 1 illustrates an example embodiment for a system and method for providing live music search, booking, and payment application according to the present invention. A Heartstrings mobile application executes on a plurality of mobile devices 110a-n connecting with music professionals 102a-n in order to connect users with musicians and their instruments 101 over the Internet 105. A web server 111 provides an on-line host through which these individuals may connect using the mobile application. The web server 111 may also include a user and musician database 112 containing all of the profile information associated with users and music professionals to permit the searching, booking, and payment activities to occur.

Users may connect with different music professionals including music therapists 104a-k, live performers 103a-m, and music buskers 102a-n. A music busker is typically an individual who performs in public in exchange for tips or small contributions from audience members who pass by. Users 110a-n may search for any of the music professionals to obtain information, reviews, contact addresses and telephone numbers, and the like. A user scrolls through the available musicians within a provided zip code obtaining a name, which could be the name of an individual musician, duo, trio, full band ensemble, etc. Example: John Smith—Guitarist/Singer/Songwriter and may find reviews, biographic information and genres, viewable performance videos, and an offer to hire.

When a musician applies to join and be included/available on Heartstrings, they will fill out standard information forms that will formulate their profile, upload a performance video, and provide financial information in order to receive payment. The consumer who may hire a musician on the App, will pay for the one hour or two hour, etc. performance up front, so as to secure the booking. This payment will be held ‘in escrow’ by Heartstrings until the musician has indicated they have completed the performance.

Pricing Information will be disclosed upfront by the musician, or ‘contact musician for pricing’. The contact would be through the App, and while eventually, a musician may provide their phone number to an inquiring user, the phone numbers for musicians, as well as their emails, typically are not made available on the App. The inquiry/offer to hire is made through the App, and back and forth communication regarding the offer is made back and forth on the App, and acceptance is made on the App. Payment upfront ‘books’ the gig. The act of hiring and payment for services must necessarily be done via the App as that will be the primary source of revenue for the App. Heartstrings The Phone App will retain a percentage of the payment.

Users then may also contact a music professional who may meet their needs and interests using their smartphone by SMS text, email, telephone call, Skype™ and FaceTime™ calls or any other communications mechanism supported by their smartphones.

Users may check availability to hire a musician for an event and schedule an appointment with a music therapist provided and managed on the web server 111 directly from the smartphone using the mobile application. Music professionals maintain profile pages containing their relevant information, reviews, contact numbers, and schedule, as well as permit the musicians to control what data is available to the users.

Lastly, users may make payments to the music professionals using any on-line payment service including credit and debit cards, PayPal™, ApplePay™, Venmo™, GooglePay™, and the like. Live musicians may receive deposits for booking an event automatically as part of the scheduling service, music therapists may collect their fees, and music buskers may receive contributions from audience members who have the mobile application on a smartphone without the need to carry cash while being out in public. In all cases, the funds are automatically transferred directly into a payment account associated with the music professional.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 111 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

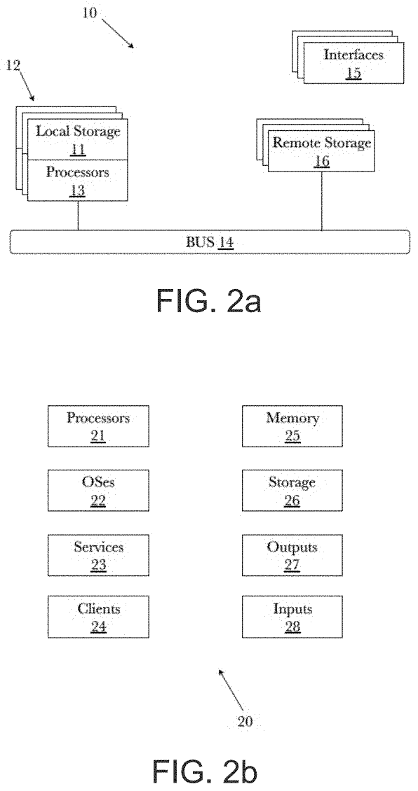

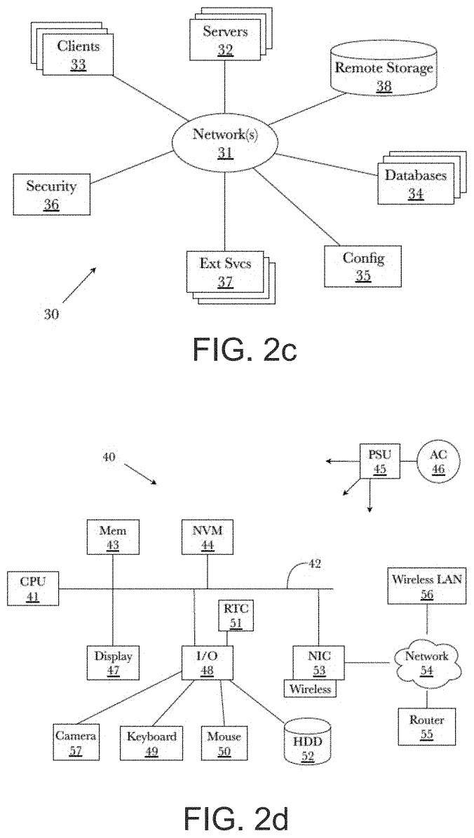

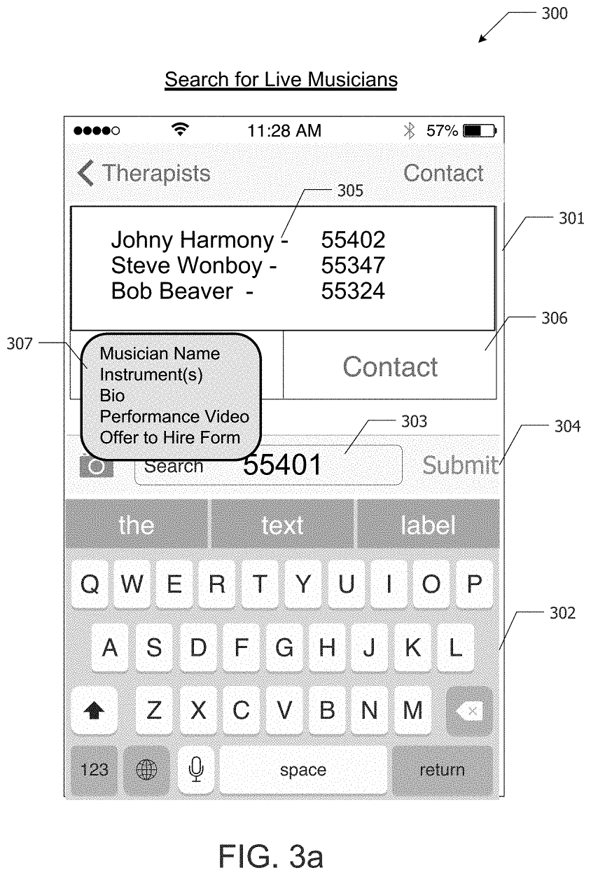

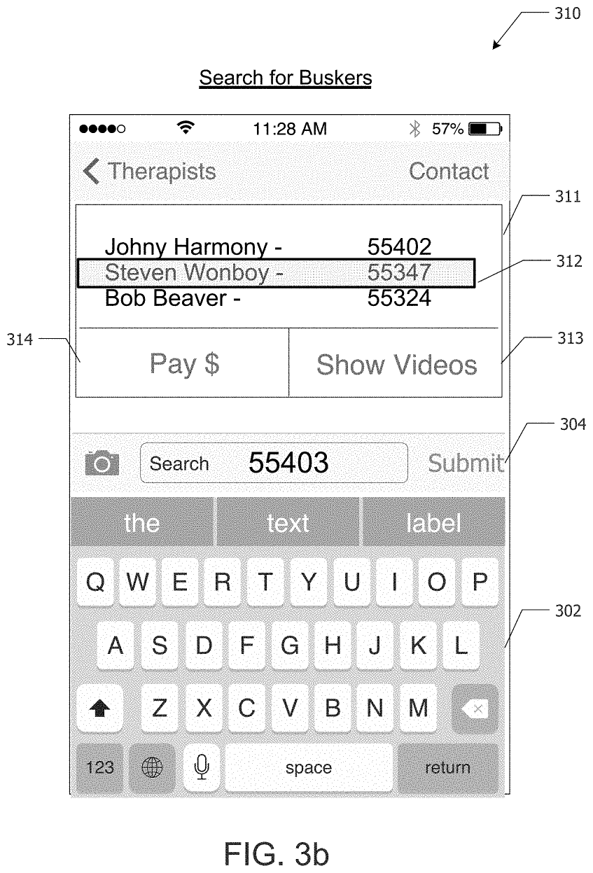

Referring now to FIG. 2a, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as, for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with a computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (such as, for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some aspects, systems may be implemented on a standalone computing system. Referring now to FIG. 2b, there is shown a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may, for example, be WINDOWS™ services, user-space common services in a Linux environment or any other type of common service architecture used with an operating system 21. Input devices 28 may be of any type suitable for receiving user input including, for example, a keyboard, touchscreen, microphone (for example, for voice input), mouse, touchpad, trackball, or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art, for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

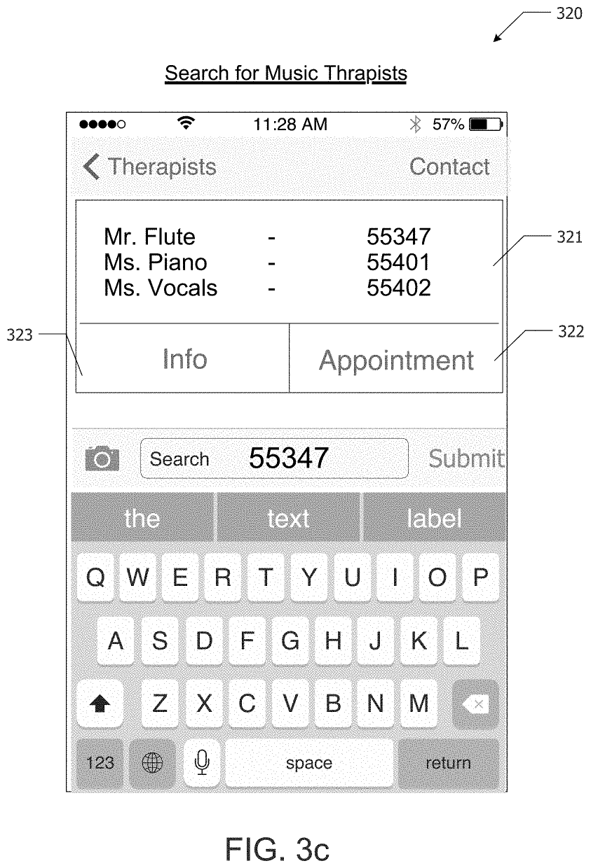

FIG. 3a-c illustrate example embodiments of user screen shots of a search function within a system and method for providing live music search, booking, and payment application according to the present invention. The first feature of the mobile application is to search for and obtain information associated with a music professional. A web server 111 provides the music professionals an ability to create a profile page including any information that is to be made available to the public. Music processionals create an account on the web server using a username and password. In some embodiments, two-factor authentication may be used to prevent malicious editing of profile pages.

Music professionals also provide their own information to the public using the mobile application. This information may include, name, address, phone number, email address, mobile number, and a profile picture. The profile page may also allow music professionals to personalize the profile page with logos, stylized text, and other visual elements to make a profile page unique to each professional if desired. A default profile page may be used if a music professional does not want to personalize the profile page.

The musician indicates which of the provided information is to be visible, which of the provided information may be accessed only using the mobile application, and which information is not accessible at any given time. This ability to classify information into these categories permits the music professional to easily change what information the public may receive. Additionally, requiring users to contact the music professional using the mobile application itself, such as by email or SMS text, permits communication to occur without needing to make personal information available publicly.

Once the profile page is created, it will be stored into a music professionals database containing all of the professionals offering services using the mobile application. Users may search for a desired type of music professional directly from the mobile application. In the embodiment disclosed herein, the mobile application permits users to search for three different classes of music professionals: live musicians as shown in FIG. 3a, music buskers as shown in FIG. 3b, and certified music therapists as shown in FIG. 3c. While the present invention presents these three classes of music professionals, one of ordinary skill will recognize that other classes of music professionals, such as song writers, jingle authors and performers, and other classes of professionals may be included in a similar manner as the examples described herein.

Each of the three search pages, Live Musicians 300, Music Buskers 310, and Music Therapists 320, all include a search field 303 and a submit button 304. Users may use an on-screen keyboard 302 to enter search data into the search field 303. The submit button 304 sends the search text to a web server 111 for use in a search of the music professional database 112. Search results 301, 311, 321 are returned and presented to the user in a text field. The search results may be context specific in that when a zip code is used to perform a location search, live musician results 301 and music therapist results 321 are shown with their zip codes, whereas the music buskers 311 may show a more specific location to aid users in finding a musician in a public space. Other result designations, such as distance from search point, may be displayed as well.

Users may select one of the musicians from the search results by clicking on the name in the results field 301, 311, 321, causing one entry to be highlighted 312. A musician may then be selected for further action using context-specific buttons 306-307, 313-314, 323-324. Any of these buttons may also include a pop-up context-specific menu 308 to provide a number of possible destinations for further actions. The context-specific buttons may be tailored to match the class of musician being searched. In a live musician search of FIG. 3a, these buttons may provide options for contact 306 and info 307, and include a pop-up menu 308. The pop-up menu 308 contains different types of additional information such as Bio, Contact Info, Reviews, Podcasts, and Music Samples. Each of these entries in the pop-up menu would access an information page created by the music professional and associated with his or her profile page.

For a music busker search of FIG. 3b, a show videos button 313 and a Pay $ button 314 are initially displayed as users may wish to access these choices to identify the musician that they have found in public or to provide a tip or contribution using an on-line payment service. Lastly, for a music therapist search, these buttons include an info button 323 which may have its own pop-up menu (not shown here see other figures) and an appointment button 322. The appointment button 322 may be used to schedule an appointment to see the professional for treatment.

The app may also include a Busking Channel of recorded live performances for viewing and is available to Users. Both consumers who may hire musicians for a live musical performance, and available musicians on the App, who have an account on the App. (similar to Uber) The busking may take place on the App. When a member musician decides they would like to busk, they simply upload a video of themselves busking. At any time, an App User may access the busking channel on Heartstrings The Phone App and view the channel. The performances will appear on the channel in the order in which they are submitted and available for a limited amount of time. This requires the musicians to constantly provide new material for App Users to watch, and App Users can ‘tip’ the buskers very easily because they have an account set up on the App again, similar to Uber. So busking can be done from anywhere on the planet. ‘Virtual Busking’. Also very similar to the YouTube™ experience, yet these performances will be exclusive to Heartstrings App users, and including the unique ability for viewers to ‘tip’. No physical location is needed, however, should the busking musician like to provide that information they can. Placards may be issued for frequent buskers to display when they are busking in a public venue so that an appreciative audience member may tip them via the App, especially in the cases where they may not have cash. By design, this approach would prompt more people to become Users of the App.

As noted above, these example buttons, pop-up menus, and other user I/O elements may be used in many other combinations. The pop-up context-specific menus may be different for each search result selected 312 depending upon what data the music professional has made public. Additionally, various search results and information data may be presented using a different number of display pages with varying organization; the example embodiments are for descriptive purposes only.

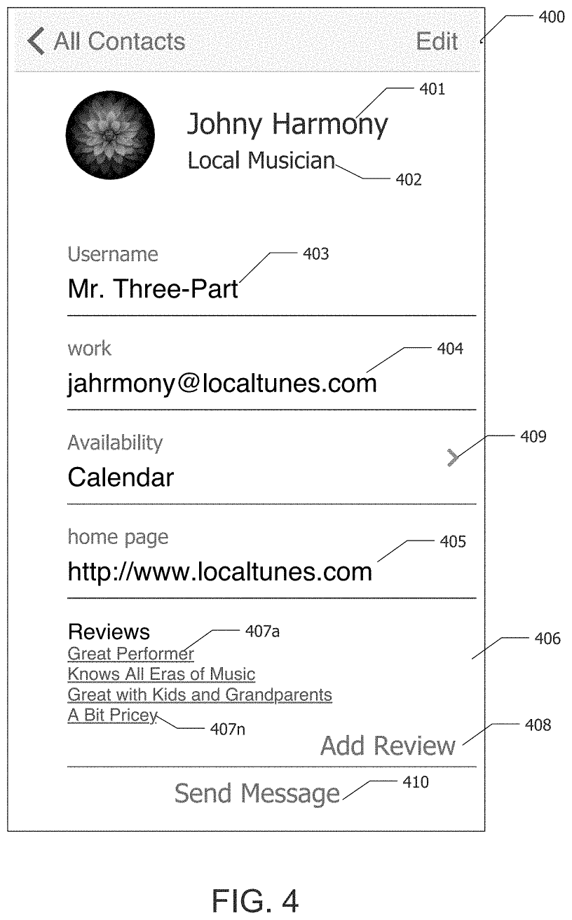

FIG. 4 illustrates another embodiment of a user screen shot of musician profile information provided by a system and method for providing live music search, booking, and payment application according to the present invention. The musician information page 400 shows a sample page with various types of information available to users of the mobile application. This information page 400 may include a phone number field 403, an email address field 404, a home page field 405, and a set of user reviews for the musician in a scrollable text field 406. The scrollable text field may contain a title of the review 407a-n that includes a hyperlink to another information page displaying the review. Music professionals may wish to include their data on a few pages or a single page for each type of information available to the public.

The scrollable text field 406 may also include an Add Review button 408 to permit the user to enter a new review that will appear in the scrollable text field 406 once submitted. Other buttons that may be useful on information pages 400 include a Call button 409 and a Send Message button 410. The web page entry 405 may also include a hypertext link to permit the user to visit the musician's home page. The mobile application may include web browser functionality permitting users to view web pages without leaving the mobile application. In other embodiments, the hypertext link will cause the mobile device to open a web browser also on the device and present the web page addressed by the hyperlink.

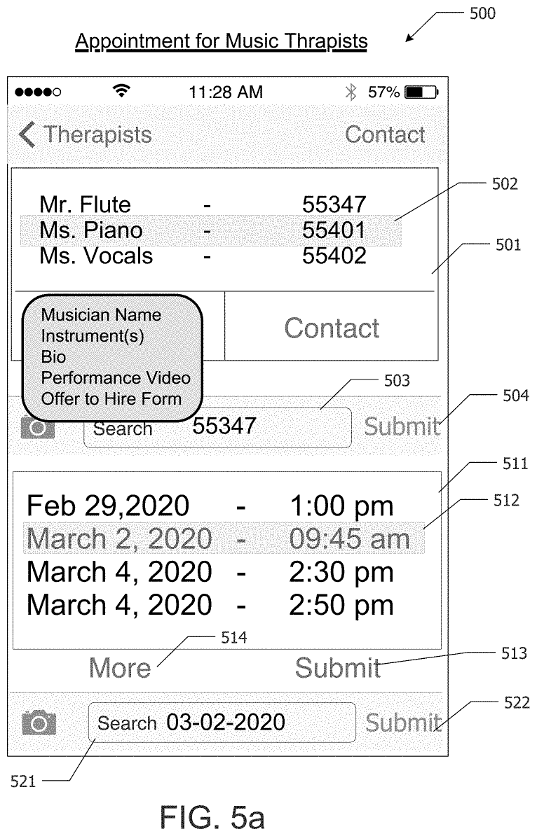

FIGS. 5a-b illustrate example embodiments of user screen shots of musician booking appointment functionality provided by a system and method for providing live music search, booking, and payment application according to the present invention. Live musicians and music therapists may use the mobile application and the web server 111 to market their services and may find an advantage if users can automatically schedule a live event or appointment directly from the mobile application.

FIG. 5a illustrates an appointment page 500 that permits a user to make an appointment to see a music therapist. In most circumstances, Clinical Music Therapists are not Doctors. They are musicians who have undergone years of training for the discipline of treating numerous physiological, psychological, neurological aspects that may exist, with a live, sometimes interactive, musical intervention.

The appointment page 500 contains a therapist search function including search results for music therapists 502 and an ability to highlight a desired therapist 502. As discussed above, a pop-up menu of therapist information may be used to research these individuals. The appointment page 500 also may present a scrollable text field 511 of available appointment times. Users enter a desired date into a date field 521 that may be submitted 522 to obtain a list of available appointments. Users select a desired appointment 512 and request that the appointment be scheduled using the Submit button 522. Credentialed Music Therapists may ‘host’ a client, and in many cases, be available to travel to a client's location. Either way. The fee to the App would merely be a set figure and not a percentage.

FIG. 5b illustrates a booking screen 520 for booking a live musician. As above, information on each musician may be obtained using a pop-up menu 524. The information and controls of the booking screen 520 operate in a similar manner as the music therapist scheduling page 500 except the search results 521 identify available live musicians and the available booking results data 525 identify dates and times when an event may be booked. A desired musician 522 is selected and a desired booking 526 for the date and time is selected. The Submit button 527 sends the request to the musician to accept or reject. In some embodiments, the Submit button 527 may take the user to a payment page to accept payment information for a deposit payment to be collected, should the live musician accept the booking request 526.

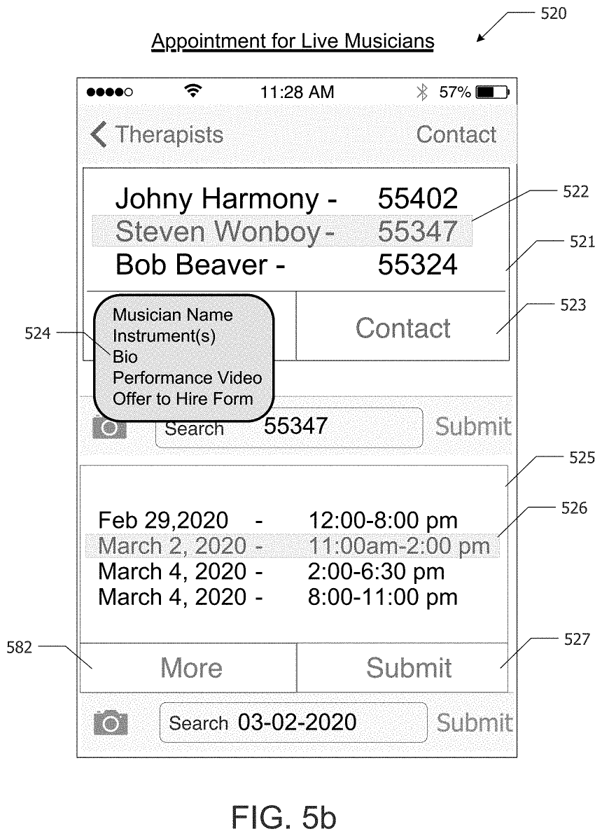

FIG. 6 illustrates another embodiment of a user screen shot of musician tip payment functionality provided by a system and method for providing live music search, booking, and payment application according to the present invention. Music buskers rely upon tips and contributions as a source of reward for performing for the public. The mobile application provides a mechanism for users to make such a contribution. The music busker may inform the audience that contributions are appreciated and accepted at Heartstrings™ mobile application, and may also indicate where the mobile application may be obtained for smartphones.

When a user wishes to make a contribution to a particular music busker, the user locates the music busker using the search function and navigates to the payment page 530 using the Pay $ button 314 of FIG. 3b. Once there, profile information 611 about the music busker is presented along with a contribution text field 602 and a date field 601. An optional review text field 610 is also provided for the user to enter a review or comment when making a contribution using comment button 613. These reviews may appear on the information page 400 discussed above. When the user has entered the information into these fields, the Give button 612 may be used to submit the contribution. If the user has already entered a default payment source into his or her profile page, the contribution may be automatically made using the default source. If the user has not entered a default payment source, the user will be presented with a screen to enter payment source information such as usernames and passwords to PayPal™, credit or debit card information, or any other information required to use a selected payment source.

Once the payment request has been entered, the payment contribution is sent by the mobile application to the web server 111 to contact the payment source to transfer the funds from the user's account to the music busker's account associated with the musician's profile. Notification of the payment may be sent to both the user to indicate that the contribution was made as well as to the music busker to inform him or her that the contribution has been received. The music busker may receive name and contact information for the user making a contribution to permit a thank you response be sent. Users may wish to make contributions anonymously and the contact information will not be provided with the payment. Users may set their profile to provide or withhold this information when making a contribution based upon a setting on the user's profile page. Music professionals may use this functionality to generate a mailing list for newsletters, upcoming event schedules, and other useful information from the music professional to known fans who have made at least one contribution.

While a similar payment to a live musician is not shown, such a payment page may be similar to FIG. 6 with the ability to enter a payment amount, indicate a payment source, and provide optional comments and reviews. The payment amount for a deposit may be set to a value, or be a minimum amount to be paid before the booking is submitted for a user request.

The overall process to utilize the present invention begins when a user downloads the mobile App for free. Consumers establish an account. Includes payment information, similar to Uber. Musicians establish an account. Includes ability to receive payment, similar to Uber. Includes populated Bio Form, and one song video of them performing. App is ‘searchable’ by name, instrument, genre, town, any specialties like Elvis, etc. Standard method; Enter the Zip Code of where the performance is to be provided. So someone in California may hire a musician anywhere in the USA for a live musical performance. For example; It's your Mother's birthday, she lives in Florida. You as the User live in CA. Cards and flowers are nice, but now you can send her a classically trained violinist to play Mozart for her for half an hour.

Once you enter the Zip Code, a list of musicians appear, (as described above), and a User may simply scroll through the available musicians. Read reviews, bios, and view performances. Once a User decides they would like to make an offer to hire, they would fill out an easy ‘gig offer’ on the App and send it to the musician. User and musician may communicate back and forth through the App.

Musician accepts the gig. The acceptance thereof on the App will include a ‘payment’ button. User makes payment upfront. Heartstrings The Phone App charges CC and holds payment ‘in escrow’. Payment cannot be released until date and time of gig has occurred. Musician indicates on App that they have completed their performance. Payment is made to the musician. User is prompted to ‘review’ musician, and if they would like, make any additional tips for an excellent performance and happy audience.

The mobile application may provide notification of all events, including the above contributions to users and music professionals, using notification functions supported by operating systems for smartphones, tablets, and personal computers. These notifications may also be used to notify users and music professionals of other events. For example, a user may receive a notification that a follow-up payment is due for an event booking or notification that the final payment for a booking is now due. When the user logs into the mobile application, the notification is provided and, if selected by the user, the corresponding payment page is shown so the user may make a payment using the mobile application. Music professionals may receive notification of a review being posted, or even notification of only 1-star and 5-star reviews that may require immediate responses.

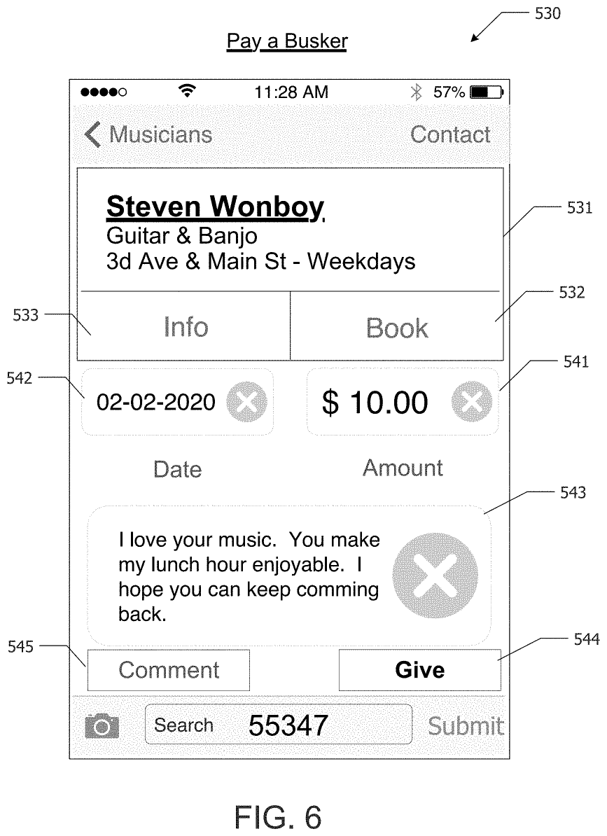

FIG. 7 illustrates a computing system of software components providing live music search, booking, and payment application according to the present invention. The computing system for providing live music search, booking, and payment application 100 is divided into two main components: a web server 111 and a user client processor 121i. The user client processor 121i typically runs on a mobile device such as a smartphone and provides users and music professionals access to the entire system to perform live music searching, booking, and payment operations. The user client processor 121i may include a mobile application 101, a mobile device display 712, and a web browsing interface 712. The mobile application 101 presents applications disclosed herein to users via mobile device display 712. Users interact using a touch-based interface of the mobile device display to provide input as needed. A web browser interface 712 provides a standard connection between the user client processor 121i to the Internet for communications with various web servers.

A web server 111 comprises a command processor 701, web interface 702, search processor 703, profile processor 704, review processor 705, payment processor 706, and scheduling processor 707. The command processor 701 receives and sends all communications with the user client processor 121i, and passes portions of any service request to the appropriate processor described below to perform searching, booking and payment operation. The command processor 701 may also communicate with external web servers such as an email server 712, payment server 711, and scheduling server 713. The email server 712 provides a mechanism for users and music professionals to send and receive messages. This email server 712 may be a standard email server set up to support the mobile application 101. The email server 712 may also be a standard email server associated with an Internet Service Provider (ISP), with an email account for each user and music professional as configured within the user client processor 121i.

The payment server 711 corresponds to one or more of the on-line payment services supported by the mobile application 101. The payment server may support credit and debit cards, PayPal™, ApplePay™, Venmo™, GooglePay™, and the like. Communication of payment requests may be sent directly from mobile application 101 or via the command processor 701 depending upon where the account information is stored for safe-keeping.

The scheduling server 713 corresponds to a web supported calendaring system such as Google Calendar™ or a dedicated calendar server such as Microsoft Outlook™. Using well-known command interfaces, the mobile application 101 and/or command processor 701 may obtain available schedule date and times and add events to the on-line calendar upon request from a user.

The search processor 703 receives and processes search queries from users for performance of searches for music professionals within the user and music professional database 112. The search processor 703 receives the query, obtains search results from the database 112, and organizes and formats the data as appropriate for display to the user. When a user accesses profile information from entries within the search results, the search processor 703 may obtain and supply the data to the mobile application 101.

The profile processor 704 provides a mechanism for users and music professionals to create accounts and user profiles, update and support maintenance of all of the possible provided pages of data depending upon the type of user and music professional, and store payment account data associated with a user for use in payment processing. The profile processor 704 provides a limited mechanism to modify the contents of the user and music professional database 112 in which most, if not all other processors accessing the database 112, may operate in a read-only fashion.

The review processor 705 receives review comments submitted by users as a review or as a comment along with a payment. The review processor 705 updates the appropriate music professional's profile to add the review for presentation when the profile is searched. The review may not be immediately posted to the music professional's profile if notice of the review is provided to the professional before making it public or if comments are reviewed for inappropriate language before posting. The review processor 705 communicates with the appropriate parties necessary for approving a review should a review require approval before posting.

The payment processor 706 sends payment requests to the appropriate payment server 711 to make a payment from a user to a music professional. The payment processor 706 obtains user payment account information from the user or from the user's profile, obtains account information for the music professional's account to receive the payment, and receives confirmation that the payment server 711 has processed the payment. The payment processor 706 may also provide notifications that payments have been made, payments are due from a user to a music professional, and refunds to a user has been provided by a music professional.

The scheduling processor 707 obtains available schedule information from a scheduling server 713 when a user attempts to schedule an appointment or book an event. This available schedule information is submitted to a user via one of the payment screens. When the user selects one of the available schedule information entries, the scheduling processor 707 creates a formal request for the event and sends it to the scheduling server 713. Music professionals may also be provided notification of the scheduling event request by the scheduling processor 707 in order to allow acceptance or rejection of the request. Users may also be provided notification of such acceptance or rejection by the scheduling processor 707.

While the embodiment of FIG. 7 discloses that the functionality of searching, contacting, and payment operations are located within a web server 111, one of ordinary skill recognizes that some or much of these functions may be located within the mobile application 101 as a matter of design choice. For example, email communications from the user and mobile application 101 to a music professional via email server 712 may occur directly in addition to occurring through a web server 111. Payment operations and scheduling operations may similarly occur directly from mobile application 101 to the respective scheduling server 713 and payment server 711. In such an embodiment, the web server is likely to receive and provide profile information regarding users and music professionals from the user and musician database 112 for account maintenance, payment, and searching. The embodiment of FIG. 7 also supports the users and music professionals use of standard web browsers running on general purpose computing devices, including smartphones, tablets, laptops, and personal computers.

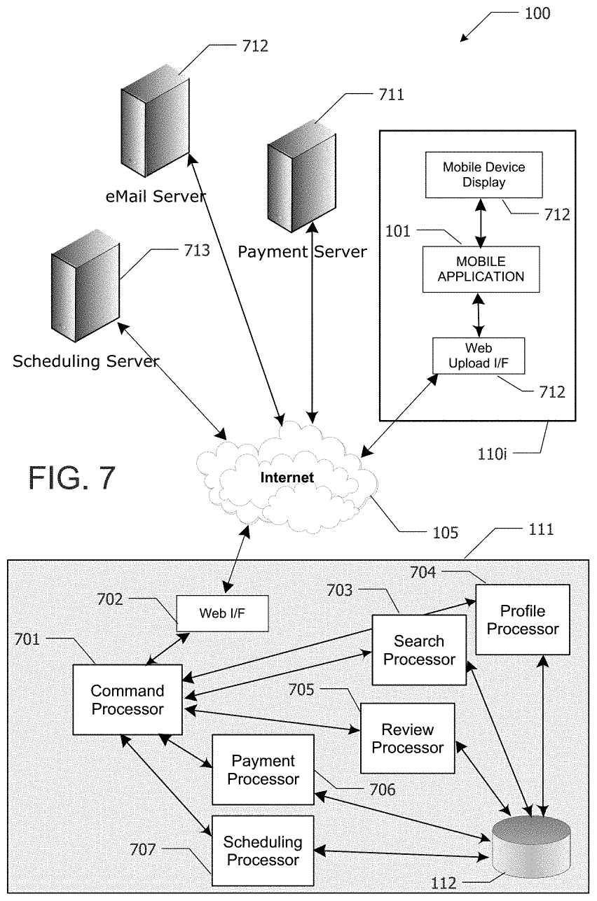

FIG. 8 illustrates a flowchart corresponding to a method performed by software components of a system for components providing live music search, booking, and payment application on a mobile device according to the present invention.

The process 800 begins 801 and in step 811, the mobile device sends a search query specifying a current location to the web server seeking an available and currently performing musician. The mobile device, in step 812, receives a set of search results, the set of search results comprising a name, a location, and a hyperlink to a musician profile.

The user selects a profile from the set of search results by activating the hyperlink, in step 813 and receives the music profile of a first musician from the set of search results, In step 814, the mobile device receives available schedule information having one or more date and time available appointments associated with the musician.

The user may schedule an appointment when the mobile device submits a schedule request to the web server scheduling a first appointment with the first musician during a first available appointments in step 815 and submits a payment to the web server for the first appointment in step 816 before the process 800 ends.

Additionally, the embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A system for providing for providing live music search, booking, and payment application for a mobile device, the mobile device communicatively connected to a web server and one or more client devices, the mobile device comprises:
a memory having instructions stored thereon; and
a processor configured to execute the instructions on the memory to cause the electronic apparatus to:
send a search query specifying a current location to the web server seeking an available and currently performing musician;
receive a set of search results, the set of search results comprising a name, a location, and a hyperlink to a musician profile;
receive the music profile of a first musician from the set of search results;
receive available schedule information having one or more date and time available appointments associated with the musician;
submit a schedule request to the web server scheduling a first appointment with the first musician during a first available appointments; and
submit a payment to the web server for the first appointment.

2. The system according to claim 1, wherein the available musicians comprises music therapists, live performers, and music buskers.

3. The system according to claim 2, wherein the payment comprises one or of the following: a deposit, a partial payment, a full payment, and a donation.

4. The system according to claim 2, wherein the available and currently performing musician comprises an individual musician, duo, trio, and full band ensemble.

5. The system according to claim 4, wherein the musician profile comprises contact information, address information, and pricing information comprising a name, an address, a phone number, an email address, a mobile number, and a profile picture associated with the available musician.

6. The system according to claim 4, wherein the payment is submitted to the web server using a third party payment service.

7. The system according to the claim 5, wherein the available musician configures the musician profile to display one or more of the following: comprising a name, an address, a phone number, an email address, a mobile number, and a profile picture.

8. The system according to the claim 5, wherein
the current location of the music therapist corresponds to an office zip code; and
the current location of the music busker corresponds to a specific location to aid users in finding a musician in a public space.

9. The system according to the claim 2, wherein the profile of the music busker comprises a show video window for viewing a live performance and a pay money button for submitting a donation.

10. The system according to the claim 9, wherein the profile of the music busker further comprises a hyperlink to a busker channel associated with the music busker providing access or one or more pre-recorded video performances for viewing.

11. A method for providing for providing live music search, booking, and payment application for a mobile device, the mobile device communicatively connected to a web server and one or more client devices, the method comprising:
sending a search query specifying a current location to the web server seeking an available and currently performing musician;
receiving a set of search results, the set of search results comprising a name, a location, and a hyperlink to a musician profile;
receiving the music profile of a first musician from the set of search results;
receiving available schedule information having one or more date and time available appointments associated with the musician;
submitting a schedule request to the web server scheduling a first appointment with the first musician during a first available appointments; and
submitting a payment to the web server for the first appointment.

12. The method according to claim 11, wherein the available musicians comprises music therapists, live performers, and music buskers.

13. The method according to claim 12, wherein the payment comprises one or of the following: a deposit, a partial payment, a full payment, and a donation.

14. The method according to claim 12, wherein the available and currently performing musician comprises an individual musician, duo, trio, and full band ensemble.

15. The method according to claim 14, wherein the musician profile comprises contact information, address information, and pricing information comprising a name, an address, a phone number, an email address, a mobile number, and a profile picture associated with the available musician.

16. The method according to claim 14, wherein the payment is submitted to the web server using a third party payment service.

17. The method according to the claim 15, wherein the available musician configures the musician profile to display one or more of the following: comprising a name, an address, a phone number, an email address, a mobile number, and a profile picture.

18. The method according to the claim 15, wherein
the current location of the music therapist corresponds to an office zip code; and
the current location of the music busker corresponds to a specific location to aid users in finding a musician in a public space.

19. The method according to the claim 12, wherein the profile of the music busker comprises a show video window for viewing a live performance and a pay money button for submitting a donation.

20. The system according to the claim 19, wherein profile of the music busker further comprises a hyperlink to a busker channel associated with the music busker providing access or one or more pre-recorded video performances for viewing.
